(19) United States
(12) Patent Application Publication
(10) Pub. No.: US 2023/0401535 A1
(43) Pub. Date: Dec. 14, 2023

(54) SYSTEM AND PROCESS FOR REDUCING HIRING BIAS

(71) Applicant: Lewis Talbot, Malibu, CA (US)

(72) Inventor: Lewis Talbot, Malibu, CA (US)

(21) Appl. No.: 16/875,021

(22) Filed: May 15, 2020

(51) Int. Cl. G06Q 10/1053

(52) U.S. Cl. CPC G06Q 10/1053

(57) ABSTRACT

The present invention comprises a system and process for delivering resumés that have had potentially bias-inducing information redacted before delivery to an employer through an online platform. Redaction under the described system and process is achieved electronically, and resumés are automatically unredacted once contact between the employer and applicant has been established through the platform.

### CROSS REFERENCE

The present Application claims the benefit of U.S. Provisional Patent Application No. 62/848,004 titled “System and Process for Reducing Hiring Bias,” filed May 15, 2019, the contents of which are incorporated in this disclosure by reference in its entirety.

### BACKGROUND

Embodiments of the invention described in this specification relate generally to employment bias, and more particularly, to a system and a process for reducing hiring bias arising prior to a job interview.

The world is incrementally progressing towards equal pay for equal work and equal rights for all men and women. Unfortunately, despite having many processes and safeguards available to employers to help facilitate fair and equal hiring practices, bias against job applicants, due to their heritage, nationality, or otherwise, still exist. Often unbeknownst to the individuals who make hiring decisions, unconscious bias is a well-documented issue arising throughout the assessment of job applications by an employer.

Unconscious bias carries the risk of treating job applicants unfairly and allowing employers to inadvertently fail to comply with prevailing discrimination and employment laws. Moreover, unconscious bias often arises long before an employer has an opportunity to meet, speak to, or even look at job applicants. Although resumes are intended to communicate to employers a job applicant's credentials and qualification for a job position, they also often contain plenty of information from which inferences and assumptions may be made, and that can result in unconscious bias against the job applicant.

Employers often try to reduce unconscious bias arising from the contents of a resume by redacting the personal information that could potentially lead to bias. Manual and electronic redaction methods have both been used by employers in the past, however, neither method has successfully eliminated unconscious bias due to the high risk of an employer's exposure to unredacted copies of applicant resumes. Manual redaction, for instance, is attempted when personal information is struck from resume hard copies using a redacting tool, such as a marker. Redaction under this method is performed by a human being, who is inevitably exposed to an unredacted copy of the resume prior to redaction. Alternatively, existing solutions provide software add-ons to candidate management systems (“CMS”) controlled by the employer. Unredacted resumes are parsed into the CMS and a computer program then sets about identifying and redacting potentially bias-sensitive data. Redacted resumes are made available to hiring managers, however, hiring managers may unredact resumes at any point thereafter, including before committing to contact an application to progress their application.

Unconscious bias often arises through an employer's access to unredacted resumes either prior to redaction or prior to the employer contacting a qualified job applicant. Accordingly, there is a need for systems and processes that redact the potentially bias-inducing information from resumes before being delivered to employers, and that maintain redaction until after an employer determines the merit of an application and contacts the applicant about continuing with the interview process. Further, there is a need for systems and processes that automatically unredact an applicant's resume information when an employer makes contact with the applicant.

### BRIEF SUMMARY OF THE INVENTION

The present invention is a system and method for redacting potentially bias-inducing resume information before delivery of a Resumé to an Employer, and maintaining redaction until the Employer contacts an Applicant to advance the application process.

The Platform may be utilized to display Job Postings and to enable Applicants to apply to posted Jobs. An Employer may create a Job Posting on the Platform by first accessing the Platform using a computer, mobile device, or any other device that provides access to the internet. An Employer may either create an account on the Platform if they do not already have an account or log in to an existing account. The Employer can then create a Job Posting on the Platform by providing information about a Job, including but not limited to a job description and/or any required skills or qualifications. Additionally, the Employer may enable the Platform's Redaction Feature, which ensures that Employer will only receive Resumés from Applicants that have redacted potentially bias-inducing information through the Platform. The Redaction Feature may be enabled at any time after the Employer creates an account on the Platform. Employer Job Postings may be stored on the Platform, and may be presented to Users to view and interact with the Job Posting, such as by viewing or applying to the Job Posting.

After an Applicant accesses the Platform by using a computer, mobile device, or any other device that provides access to the interne, the Applicant may then search for Job Postings on the Platform. If the Applicant comes across an interesting or intriguing Job Posting, the Applicant may choose to submit his or her Resumé Employer who created the Job Posting. If the Employer has enabled the Redaction Feature, potential bias-inducing information will be redacted from the Applicant's Resumé and the redacted Resumé will be delivered to the Employer through the Platform. The Employer may then review the redacted Resumé, and if desired, may then message or otherwise contact the Applicant through the Platform. Utile Employer contacts the Applicant through the Platform, all information previously redacted by the Redaction Feature will become visible when the Employer views the Applicant's Resumé through the Platform. If the Employer has not enabled the Redaction Feature, no information will be redacted from the Applicant's Resumé and a non-redacted Resumé will be delivered to the Employer through the Platform. The Employer may then review the non-redacted Resumé, and decide how to proceed with the Applicant.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 conceptually illustrates a process for an Employer to create a Job Posting on a Platform and/or enable a Redaction Feature.

FIG. 2 conceptually illustrates a process of an Applicant applying to a Job Posting, Applicant information redaction, and information delivery to an Employer.

FIG. 3 illustrates one embodiment of a Resumé that has been redacted by a Redaction Feature.

### DETAILED DESCRIPTION OF THE INVENTION

As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the terms and variations thereof have the meanings given below, unless a different meaning is clearly intended by the context in which such term is used.

An “Applicant” is an individual that applies for a Job.

An “Employer” is an individual, entity, institution, or organization, or establishment looking to obtain the services of at least one individual.

A “Job” is an opportunity to render services in exchange for or without compensation, including but not limited to an employment opportunity, a position requesting services from an independent contractor, an internship, an externship, an apprenticeship, a fellowship, or a volunteer position.

A “Job Posting” is a presentation of certain information pertaining to a Job by means of a Platform.

The “Platform” is a means for collecting, storing, sharing, and presenting information from and between Applicants and Employers over the internet.

“NDUID” stands for non-descript unique identifier.

A “Resumé” is a written account of personal, educational, and professional qualifications and experience, as that prepared by an Applicant.

The “Redaction Feature” is a feature of a Platform that redacts potentially bias-inducing Applicant information from a Resumé.

A “User” is an Applicant or Employer that has been granted access to certain information stored by the Platform.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present disclosure is to be considered as an exemplification of the invention, and is not intended to limit the invention to the specific embodiments illustrated by the figures or description below.

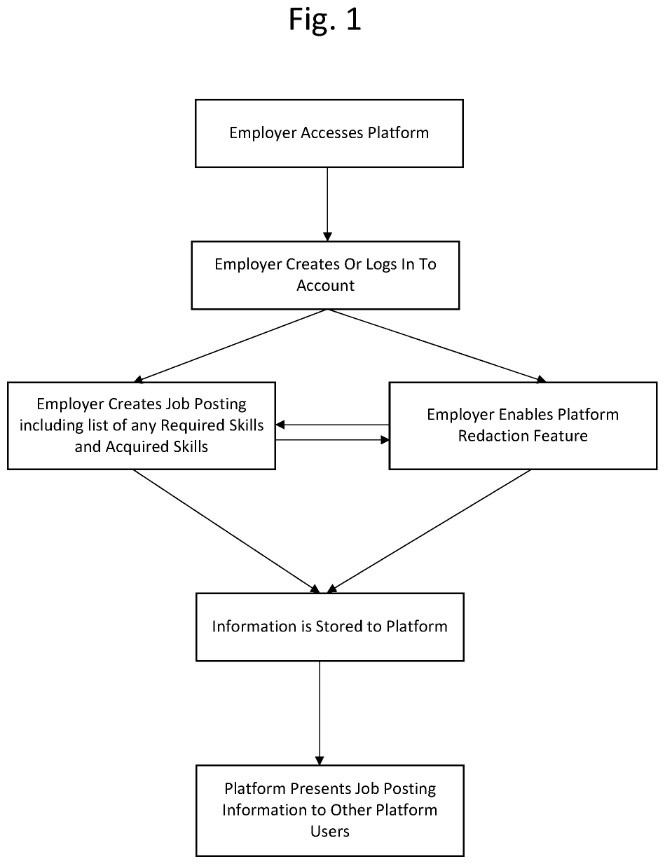

Referring now to the invention in more detail, FIG. 1 conceptually illustrates a process for an Employer to create a Job Posting on a Platform. The first step is for an Employer to access the Platform. This may be done using a computer, mobile device, or any other device that provides access to the internet. Subsequently, the Employer may either create an account on the Platform if they do not already have an account or log in to an existing account. Next, the Employer can create a Job Posting on the Platform by providing information about a Job, including but not limited to a job description and/or any required skills or qualifications. any Required Skills or Acquired Skills that pertain to the Job. Additionally, the Employer may enable the Platform's Redaction Feature. This step may be performed at any time after Employer account creation. Next, information pertaining to the Employer's Job Posting is stored on the Platform. Finally, the Platform makes it possible for Users to view and interact with the Job Posting, such as by viewing or applying to the Job Posting.

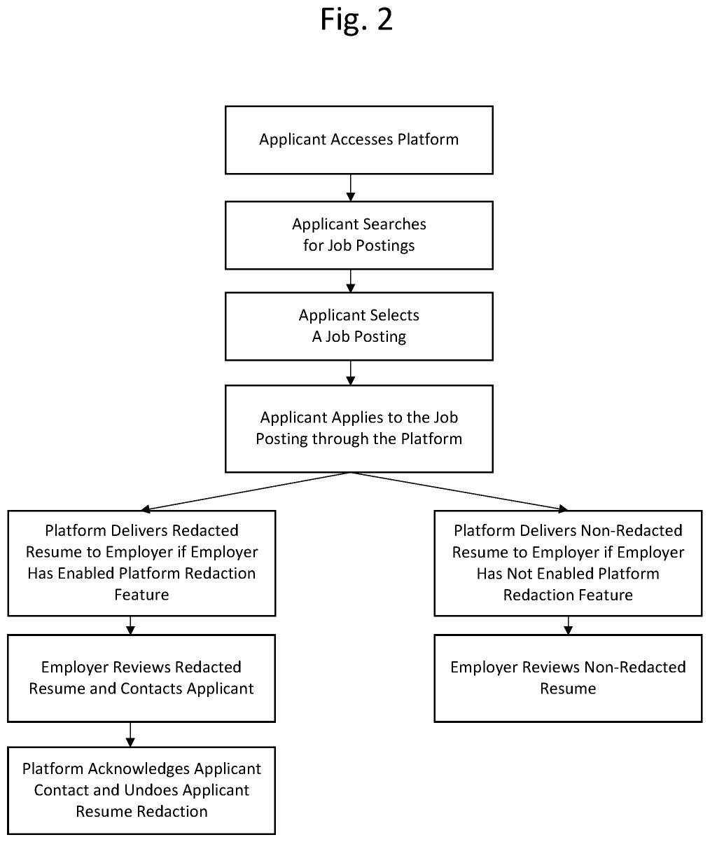

Referring to FIG. 2, FIG. 2 conceptually illustrates an embodiment of the process of an Applicant applying to a Job Posting, Applicant information redaction, and information delivery to an Employer via a Platform. As shown, an Applicant must first access the Platform. This may be done using a computer, mobile device, or any other device that provides access to the internet. An Applicant may then search for Job Posting on the Platform. Next, the Applicant may identify a Job Posting of interest. Then, the Applicant may choose to submit his or her Resumé Employer who created the Job Posting. If the Employer has enabled the Redaction Feature, potential bias-inducing information will be redacted from the Applicant's Resumé and the redacted Resumé will be delivered to the Employer through the Platform. The Employer may then review the redacted Resumé, and if desired, may then message or otherwise contact the Applicant through the Platform. If the Employer contacts the Applicant through the Platform, all information previously redacted by the Redaction Feature will become visible when the Employer views the Applicant's Resumé through the Platform. If the Employer has not enabled the Redaction Feature, no information will be redacted from the Applicant's Resumé and a non-redacted Resumé will be delivered to the Employer through the Platform. The Employer may then review the non-redacted Resumé, and decide how to proceed with the Applicant.

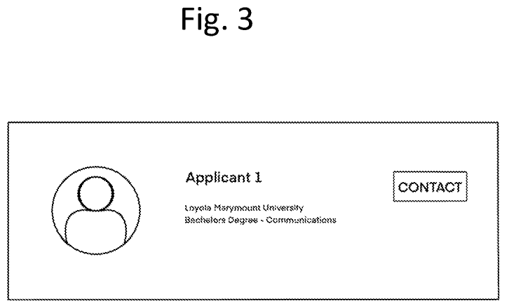

FIG. 3 illustrates one embodiment of a Resumé that has been redacted by a Redaction Feature. FIG. 3 shows an example of an Applicant Resumé wherein Applicant's name has been replaced by a NDUID, and Applicant's picture, “current location,” “hometown,” and “languages” have been removed. Information may be redacted using any reliable method, including but not limited to the replacement of information with an NUID, covering information, removing information, or obscuring information.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system for reducing hiring bias comprising;
a Platform displaying Job Postings to Users;
a means for Employer Users to create Job Postings for display on the Platform;
a means for Applicant Users to apply to a Job Posting by submitting information through the Platform to the Employer Users who created the Job Posting;
a Redaction Feature which prevents an Employer User from viewing potentially bias-inducing information pertaining to Applicant Users who apply to a Job Posting created by the Employer User on the Platform; and
a means for an Employer User to contact Applicant Users who apply to a Job Posting created by the Employer User on the Platform.

2. The system of claim 1 wherein an Employer User may enable and disable the Redaction Feature.

3. The system of claim 1 wherein redacted potentially bias-inducing information pertaining to an Applicant User who applies to a Job Posting created by the Employer User on the Platform becomes unredacted once the Employer User contacts the Applicant User through the Platform.

4. A method for reducing hiring bias comprising;
the creation of Job Postings by Employer Users on a Platform;
the displaying of Job Posting by Employer Users on the Platform to Applicant Users on the Platform;
the enabling of a Redaction Feature by an Employer User;
the applying to a Job Posting by an Applicant User, wherein the Job Posting was posted by an Employer User who has enabled the Redaction Feature, and the Applicant User submits information through the Platform to the Employer User in response to the Job Posting;
the identification of potentially bias-inducing information submitted by the Applicant User in response to a Job Posting by the Platform prior to delivering information submitted by the Applicant User to the Employer User who created the Job Posting;
the redaction of potentially bias-inducing information submitted by the Applicant User in response to a Job Posting by the Platform prior to delivering information submitted by the Applicant User to the Employer User who created the Job Posting;
the contacting of the Applicant User who submitted information in response to a Job Posting by the Employer User who has enabled the Redaction Feature;
the revealing of redacted information pertaining to an Applicant User by the Platform to the Employer User who has enabled the Redaction Feature once the Employer User contacts the Applicant User through the Platform.

5. The method of claim 4 wherein redacted information is substituted by a NDUID.

6. The method of claim 4 wherein potentially bias-inducing information includes an Applicant User's name.

7. The method of claim 4 wherein potentially bias-inducing information includes an Applicant User's gender.

8. The method of claim 4 wherein potentially bias-inducing information includes an Applicant User's race.

9. The method of claim 4 wherein potentially bias-inducing information includes an Applicant User's ethnicity.

10. The method of claim 4 wherein potentially bias-inducing information includes an Applicant User's age.

11. The method of claim 4 wherein potentially bias-inducing information includes an Applicant User's hometown.

12. The method of claim 4 wherein potentially bias-inducing information includes an Applicant User's current location.

13. The method of claim 4 wherein potentially bias-inducing information includes an Applicant User's picture.
